(19) United States
(12) Patent Application Publication
(10) Pub. No.: US 2014/0100670 A1
(43) Pub. Date: Apr. 10, 2014

(54) METHOD AND A SYSTEM FOR ONLINE AND DYNAMIC DISTRIBUTION AND CONFIGURATION OF APPLICATIONS IN A DISTRIBUTED CONTROL SYSTEM

(71) Applicant: ABB RESEARCH LTD, Zurich (CH)

(72) Inventors: Sanjay GOSH, Bangalore (IN); Mallikarjun Kande, Bangalore (IN); Venkateswaran Narayanan, Bangalore (IN); Sanjeev Koul, Bangalore (IN); Michael Wahler, Zurich (CH); Stefan Richter, Fislisbach (CH)

(73) Assignee: ABB RESEARCH LTD, Zurich (CH)

(21) Appl. No.: 14/082,967

(22) Filed: Nov. 18, 2013

Related U.S. Application Data
(63) Continuation of application No. PCT/IB2011/003123, filed on Dec. 22, 2011.

(30) Foreign Application Priority Data
May 16, 2011 (IN) 1668/CHE/2011

(51) Int. Cl. G05B 19/418

(52) U.S. Cl. CPC G05B 19/4185
USPC 700/20

(57) ABSTRACT

Exemplary embodiments are directed to a method and system of online and dynamic distribution and configuration of applications in a Distributed Control System (DCS) of a plant. One or more applications of at least one controller of the DCS is divided into a plurality of blocks. The application is changed by managing each of the blocks. The one or more blocks is dynamically distributed to at least one other controller of the DCS. The data distributed to the at least one other controller is synchronized between the other controllers. The application associated with the distributed data is managed based on an operation schedule of the DCS.

### RELATED APPLICATION

This application claims priority as a continuation application under 35 U.S.C. §120 to PCT/IB2011/003123, which was filed as an International Application on Dec. 22, 2011 designating the U.S., and which claims priority to Indian Application 1668/CHE/2011 filed in India on May 16, 2011. The entire contents of these applications are hereby incorporated by reference in their entireties.

### FIELD

The disclosure relates to control applications in a distributed control system, and more particularly to a method and a system for online and dynamic distribution and configuration of applications in a distributed control system.

### BACKGROUND INFORMATION

Distributed Control System (DCS) can be employed in a process control plant for controlling plant processes. DCS has real time controllers that are used as embedded devices, which can include but are not limited to an industrial Personal Computer (PC), Programming Logic Controller (PLC), any computing unit capable of providing real time execution environment to control applications, or any other suitable computing device as desired. DCS controllers can be used to manage real time control applications, communication interfaces, field devices, or other suitable components or aspects of the plant as desired, through industrial automation.

It should be understood that proper control of the processes can influence the proper functioning or operation of the plant. The processes referred here can include factors relating to hardware, applications, workflow, or any other suitable properties as desired. Any change in these factors, such as the applications, which can be referred to as control applications, can influence and impact the operation of the plant. These factors are constrained by one or more of the system configuration, hardware capability, communication, current state of the process, and the process capabilities thereof, where applicable.

Under certain conditions during its operation, the plant can adopt or encounter changes or modifications in one or more processes with regard to one or more of the factors mentioned here above. Moreover, changes purporting to control applications can become so significant that they should be addressed online e.g., during the operation of the plant. This also means that the plant operation should not be stopped or suspended, but the specified changes should be incorporated without disturbing the plant operation or of the sequence thereof.

It can be difficult to adopt the above changes or modifications as stated above, because in some instances the changes do not involve mere distribution of applications dynamically, but specifies one or more of adding, deleting, modifying, and cascading, or other suitable formulation as desired, of additional or new control schemes of the plant based on the changes or modifications that a plant encounters during the processes. Also, besides the distribution of applications, their run time states should be maintained, synchronized, and shared to enable seamless migration and distribution thereby, that is transparent to the process or any other element or components in the plant.

Hence, the present disclosure is directed to resolution of issues surrounding control applications, such as those relating to their change or modification, dynamically in real time (e.g., online) without disturbing operation of the plant.

### SUMMARY

An exemplary method of dynamic distribution and configuration of applications in a Distributed Control System (DCS) that employs one or more of Commercial off-the-shelf (COTS) components, computing devices, and/or a plurality of controllers, in an online plant is disclosed, the method comprising: dividing, in at least one first controller, one or more applications into a plurality of blocks; changing features of the one or more applications by modifying at least one of the plurality of blocks; distributing the plurality of blocks of the one or more applications to at least one second controller; synchronizing data of the plurality of distributed blocks between the at least one second controller; and managing the one or more applications associated with the blocks of synchronized data based on an operation schedule of the online plant.

An exemplary system for online and dynamic distribution and configuration of applications in a Distributed Control System (DCS) of a plant that employs one or more of Commercial off-the-shelf (COTS) components, and computing devices is disclosed, the system comprising: a plurality of controllers having a real time operating system, wherein each controller is configured to include: a controller abstraction framework which has a local management component for locally managing and scheduling applications running in a respective controller; and a runtime management component for maintaining a runtime global topology and configuration of the distributed control system, and communicating with other controllers through a communication medium.

An exemplary computing device of a Distributed Control System (DCS) in a plant that employs one or more of Commercial off-the-shelf (COTS) components is disclosed, the device being configured to include a real time operating system having a controller abstraction framework which has a local management component for locally managing and scheduling applications, and a runtime management component for maintaining a runtime global topology and configuration of the distributed control system, and communicating with other computing devices through a communication medium, the computing device being configured to: divide one or more applications into a plurality of blocks; dynamically distribute at least one of the plurality of blocks to at least one other computing device; synchronizing data between the plurality of distributed blocks; and managing the one or more applications associated with the synchronized blocks based on an operation schedule of the plant.

### BRIEF DESCRIPTION OF THE DRAWINGS

Exemplary embodiments will be described with reference to the accompanying drawings, in which:

FIG. 1 illustrates a schematic diagram of a system in accordance with an exemplary embodiment of the present disclosure.

### DETAILED DESCRIPTION

Exemplary embodiments of the present disclosure provide a method by which online distribution and sharing of control applications can be achieved.

Exemplary embodiments of the present disclosure also provide a method by which modification or patching of only specified portions of a running control application is affected without disturbing the execution, logic, state or behavior of any other portions of the the control applications or any of its sequence.

Exemplary embodiments described herein provide a system and a method for running the controllers in a DCS at an optimal threshold load, and provide a system and a method in which solution for redundancy of controllers for fault is offered.

An exemplary embodiment of the present disclosure provides a method of online and dynamic distribution and configuration of applications in a Distributed Control System (DCS) of a plant. The DCS employs one or more of Commercial off-the-shelf (COTS) components, industrial PC, PLC, or other suitable computing or programmable device as desired, and has a plurality of controllers. The exemplary method of the present disclosure includes one or more steps of dividing or separating one or more applications correspondingly into one or more blocks. Further the method includes performing dynamic changes to the application, managing each of the blocks and of its corresponding applications. Also, the exemplary method can include performing a dynamic distribution of one or more blocks of one or more applications across one or more controllers. This can be followed by synchronizing run time data between one or more of the distributed blocks, and managing the applications and the operation schedule thereof.

Another exemplary embodiment of the present disclosure provides a system for online and dynamic distribution and configuration of applications in a Distributed Control System (DCS) of a plant. The DCS employs one or more of Commercial off-the-shelf (COTS) components, industrial PC, PLC, or other suitable programmable device as desired, and has a plurality of controllers. The exemplary system can include a plurality of controllers, in which each of the controllers uses a real time operating system or management application. Each of controller includes a controller abstraction framework having a local management component for locally managing and scheduling the applications running in the controller. In addition, the exemplary system can include a runtime management component for maintaining the runtime global topology and configuration, and communicating with the controllers through a communication medium.

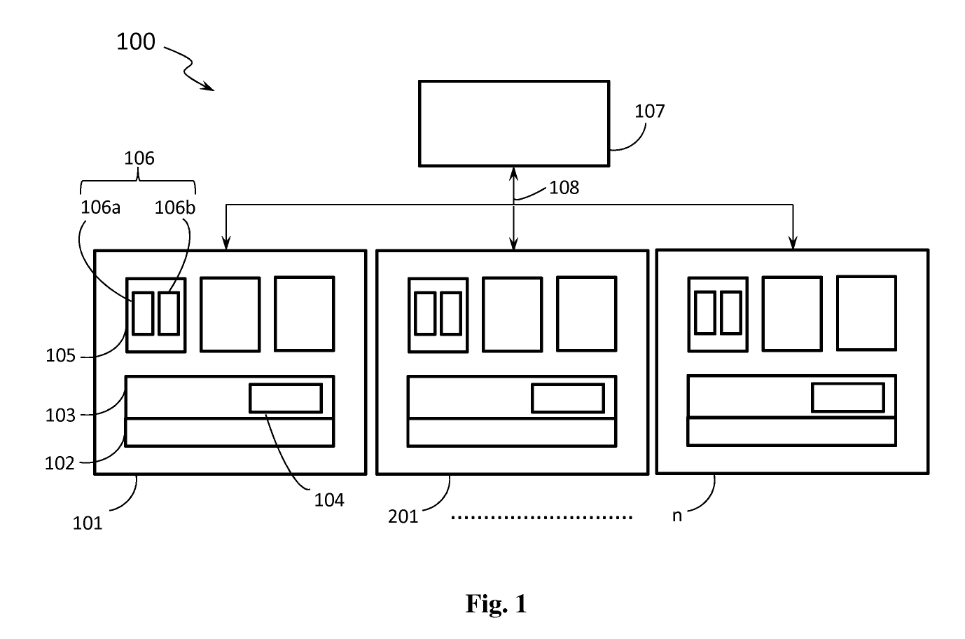

FIG. 1 illustrates a schematic diagram of a system in accordance with an exemplary embodiment of the present disclosure. As shown in FIG. 1, the system (100) is configured for online and dynamic distribution and configuration of applications in a Distributed Control System (DCS) having a plurality of controllers (101, 201, . . . n), in a plant.

The controller (101) uses a real time operating system or management application (102) for its operation. These controllers control the processes of the plant. It should be understood that the processes can encounter some changes or modifications during runtime, e.g., when the plant is online, without disturbing or suspending the operation of the plant. The exemplary system is also configured to address runtime conditions. The exemplary controller (101), therefore, can include a controller abstraction framework (103) which caters to managing and scheduling the execution of applications in the controller (101) by a local management component (104) within the controller abstraction framework (103).

Under certain conditions, there may be one or more applications (105) running in a controller. These applications can be separated or divided into portions such that each of these portions, e.g., blocks (106a, 106b, . . . ) as provided in the context of the present disclosure, can be independent logical blocks (106). These blocks (106) correspond to an application (105) that can be executed independently and has respective runtime state and data. Blocks (106) can communicate and share runtime state and data with one or more other blocks in the same application or blocks of other applications running in the same controller or in other controllers. Also, the applications or control applications can be executed in a manner independent to the controllers.

When a condition under which a dynamic change such as adding, deleting, modifying, or cascading, additional or new control schemes arises, or under which the dynamic changes to logic or to an algorithm of a running application arises, the block that includes the relevant logic or algorithm data for implementing the change is modified as desired. As a result, changes in the process can be accommodated.

In an exemplary embodiment, conditions can arise in which the operation of the plant or of the process running should be protected against being disturbed or suspended. Under these conditions, the local management component (104) in the controller abstraction framework (103) of the controller (101) can manage each and every block along with its respective runtime state and data. This allows the associated blocks to be executed in a different controller than in the controller in which these blocks are currently being or are to be executed.

A real time management component (107) can manage the runtime global topology pertaining to all the controllers that are distributed in the DCS. As a result, the real time management component (107) can allow and maintain the configuration/reconfiguration of the topology with respect to the distribution of the blocks across controllers for its execution and also accounting for any dynamic changes as desired.

The real time management component (107) and the controllers (101, 201, . . . n) can communicate with each other and share a runtime state, data, and other relevant information through a communication medium (108). The communication medium (108) provides for the establishing and maintaining of a communication channel between the real time management component (107) and each of the controllers (101, 201, . . . n), and also between the controllers (101, 201, . . . n) themselves, for the communication of operation, configuration, and/or control data.

During the dynamic distribution operation, the real time management component (107) can logically map the applications and the blocks relating to one or more of these applications with the hardware nodes of one or more controllers (106). As a result, scheduling of the applications with relevance to its blocks across one or more controllers (101, 201, . . . n) is performed based on the specified dynamic change and load across each controller. Morevoer, according to an exemplary embodiment of the present disclosure, one or more blocks of one or more applications in a controller (101, 201, . . . n) can be migrated to another controller and executed. The execution of the one or more blocks permits the respective block(s) to be changed dynamically in real time. In addition, the respective one or more blocks can be also optimally and dynamically distributed. As a result of this process, the controllers (101,201, . . . n) can operate at an optimal threshold load, which can also minimize the number of controllers to be deployed in the DCS to a specified minimum threshold amount.

Exemplary embodiments of the present disclosure provide for the redundancy of controllers upon the occurrence of fault conditions. In the event a controller experiences a fault condition, the one or more applications corresponding to the controller can be fully or partially distributed or migrated to one or more controllers through seamless transfer of runtime states, and data of the respective one or more blocks and of the respective applications thereof. The distribution or migration of one or more blocks of data of one or more applications of a controller during a normal operation or during a fault condition can be managed by the real time management component (107) either alone or in combination with the local management component (104). As a result, the runtime state and data of all the blocks can be transparent across the controllers and the real time management component (107).

An exemplary embodiment of the present disclosure provides for identifying (e.g., detecting) one or more controllers experiencing a fault condition, and the one or more controllers operating under normal working conditions. The identification is performed under specified parameters to enable the applications of a controller under a fault condition to be run or executed in one or more controllers operating normally (e.g., non-fault condition) within specified time constraints. In another exemplary embodiment, multiple copies of one or more applications of a controller under a fault condition can be executed in two or more controllers as desired.

In another exemplary embodiment of the present disclosure, one or more controllers can be dynamically added, inserted, or removed from the system. In an exemplary embodiment, the removal of one or more controllers can be focused on any of the one or more controllers or regulated to those one or more controllers under a fault condition as desired.

During or after the dynamic distribution process, the runtime state and data between one or more of the blocks that are either distributed or being distributed can be synchronized, wherein the execution schedule of the blocks can be managed online.

Exemplary embodiments of the disclosure can include any type of controller that can be configured to provide the features and execute the functions described herein.

The present disclosure is explained by way of exemplary embodiment and is neither exhaustive nor limiting. Certain aspects of the disclosure that not been elaborated are well understood by one skilled in the art. Also, the terms relating to singular form used herein in the description also include its plurality and vice versa, wherever applicable. Any relevant modification or variation, which is not described specifically in the specification are in fact to be construed of being well within the scope of the disclosure.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of dynamic distribution and configuration of applications in a Distributed Control System (DCS) that employs one or more of Commercial off-the-shelf (COTS) components, computing devices, and/or a plurality of controllers, in an online plant, the method comprising:
dividing, in at least one first controller, one or more applications into a plurality of blocks;
changing features of the one or more applications by modifying at least one of the plurality of blocks;
distributing the plurality of blocks of the one or more applications to at least one second controller;
synchronizing data of the plurality of distributed blocks between the at least one second controller; and
managing the one or more applications associated with the blocks of synchronized data based on an operation schedule of the online plant.

2. The method as claimed in claim 1, wherein each of said one or more blocks is an independent logical block of a corresponding application that is independently executable and having a respective runtime state and data, the method comprising:
communicating and sharing runtime state and data with one or more other blocks of the corresponding application or one or more other blocks of another application provided in the at least one first controller or in the at least one second controller.

3. The method as claimed in claim 1, comprising:
executing the one or more applications independently of the first or second controller.

4. The method as claimed in claim 1, comprising:
performing dynamic changes to logic or an algorithm of the one or more applications.

5. The method as claimed in claim 4, comprising:
at least one of adding, deleting, modifying, or cascading of additional or new control schemes of the plant.

6. The method as claimed in claim 1, wherein managing each of the blocks and the corresponding application comprises:
managing a runtime state and data of each of the blocks and the corresponding application.

7. The method as claimed in claim 1, wherein distributing the plurality of blocks of the one or more applications to the at least one second controller comprises:
logically mapping at least one of the one or more applications and at least one of the plurality of blocks with hardware nodes associated with the at least one second controller.

8. The method as claimed in claim 1, wherein distributing the plurality of blocks of the one or more applications to the at least one second controller comprises:
distributing at least one of the plurality of blocks of at least one first controller under a fault condition across at least one second controllers operating normally to enable the one or more applications of the at least one first controller to be executed in the at least one second controller.

9. The method as claimed in claim 1 wherein distributing the plurality of blocks of the one or more applications to at least one second controller comprises:
enabling the at least one second controller to operate at an optimal threshold load.

10. The method as claimed in claim 7, wherein distributing the plurality of blocks of the one or more applications to at least one second controller comprises:
detecting at least one first controller operating under a fault condition, and identifying at least one second controller that is operating normally and is capable of executing the applications of the at least one first controller within an allowable time constraint.

11. The method as claimed in claim 8, comprising:
distributing the one or more blocks associated with at least one first controller operating under a fault condition to at least one second controller operating normally by transferring runtime states and data of the one or more blocks.

12. The method as claimed in claim 5, comprising:
executing multiple copies of one or more applications in at least two second controllers.

13. The method as claimed in claim 1, comprising:
at least one of adding, inserting, or removing the at least one first controller to or from the online plant.

14. The method as claimed in claim 13, wherein the at least one first controller is removed when detected as operating under a fault condition.

15. The method as claimed in claim 1, wherein the one or more controllers of the online plant is operating normally, the method comprising:
maintaining a sequence of operations of the plurality of controllers or the plant.

16. The method as claimed in claim 3, wherein at least one of the one or more applications is a control application.

17. The method as claimed in claim 4, wherein the application is an application that is being executed.

18. A system for online and dynamic distribution and configuration of applications in a Distributed Control System (DCS) of a plant that employs one or more of Commercial off-the-shelf (COTS) components, and/or computing devices, the system comprising:
a plurality of controllers having a real time operating system, wherein each controller is configured to include:
a controller abstraction framework which has a local management component for locally managing and scheduling applications running in a respective controller; and
a runtime management component for maintaining a runtime global topology and configuration of the distributed control system, and for communicating with other controllers through a communication medium.

19. The system as claimed in claim 18, wherein the runtime management component is configured to dynamically distribute and configure one or more blocks of applications executed by a respective controller.

20. A computing device of a Distributed Control System (DCS) of a plant that employs one or more of Commercial off-the-shelf (COTS) components, the device being configured to include a real time operating system having a controller abstraction framework which has a local management component for locally managing and scheduling applications, and a runtime management component for maintaining a runtime global topology and configuration of the distributed control system, and for communicating with other computing devices through a communication medium, the computing device being configured to:
divide one or more applications into a plurality of blocks;
dynamically distribute at least one of the plurality of blocks to at least one other computing device;
synchronizing data between the plurality of distributed blocks; and
managing the one or more applications associated with the blocks of synchronized data based on an operation schedule of the plant.
